(19) United States
(12) Patent Application Publication
(10) Pub. No.: US 2017/0292317 A1
(43) Pub. Date: Oct. 12, 2017

(54) ACTIVE GLAZING SYSTEM

(71) Applicants: UNIVERSITE PIERRE ET MARIE CURIE (PARIS 6), Paris (FR); CENTRE NATIONAL DE LA RECHERCHE SCIENTIFIQUE - CNRS, Paris Cedex 16 (FR)

(72) Inventors: David GROSSO, Cheptainville (FR); Marco FAUSTINI, Paris (FR); Cedric BOISSIERE, Villebon Sur Yvette (FR)

(21) Appl. No.: 15/512,897

(22) PCT Filed: Sep. 24, 2015
(86) PCT No.: PCT/FR2015/052554

§ 371 Date: Mar. 21, 2017

(30) Foreign Application Priority Data
Sep. 25, 2014 (FR) 1459061

(51) Int. Cl. E06B 3/67; E06B 9/24; G02B 5/02

(52) U.S. Cl. CPC E06B 3/6722; G02B 5/0205; E06B 9/24; E06B 2009/2417

(57) ABSTRACT

An active glazing system (100) includes a double glazing, with two transparent plates (1a, 1b) that together delimit an intermediate volume (2) filled with gas. The system further includes a control device (10) that is capable of producing a transition in a volatile compound present in the intermediate volume, between a dry vapor state and a supersaturated vapor state of the volatile compound. Switching processes can therefore be controlled for the double glazing, between a transparent optical state and a diffusing optical state. Such a system can be used as building or vehicle glazing, an interior partition arrangement, a projection screen, a solar diffuser, a light source diffuser, a vision blurring device, etc.

This invention relates to an active glazing system.

Certain active glazing applications aim to obtain isolation or intimacy without resulting in obscurity. For example, active glazing is installed to separate two rooms within built premises, such as a meeting room and a corridor passageway, while transmitting ambient light between the room and the corridor. For this purpose, the active glazing, upon command, reversibly switches between a transparent state, wherein it transmits the light rays without their deflection, and a diffusing, or translucent state, wherein the light rays are deflected simultaneously in multiple directions. The transparent state therefore corresponds to the capacity of the glazing to transmit the light in a specular manner, allowing for a distinct view through the glazing. Conversely, the diffusing state blurs the view to an extent that can suffice to fully obstruct the view, and thus result in visual isolation.

In the remainder of this description, transparency will be understood as being the capacity of the glazing to transmit light in a specular manner. Transparency can thus be quantified by the specular light transmission value. Conversely, the light diffusion efficiency, also referred to as translucency, can be quantified by the non-specular light transmission value. Transparency can be measured by placing a light detector on one side of the glazing, in line with a light beam that is directed from the other side of the glazing. Conversely, translucency can be measured by angularly shifting the detector in relation to the axis of the incident light beam.

Such active glazings that switch between a transparent state and a diffusing state already exist. They are produced using a PDLC film (abbreviation for polymer-dispersed liquid crystal), that is arranged between two electrode layers. On the one hand, the PDLC film is an expensive component, however the production of electrode layers also contributes to significantly increasing the cost price of the active glazing. Indeed, such electrodes are made from tin-doped indium oxide, or from fluorine-doped tin oxide, and require the use of specific deposition methods.

Finally, the assembly of an active glazing with a PDLC film base is complicated, and is not compatible with acoustic or thermal insulation performance levels that may also be required.

One purpose of this invention therefore consists in proposing a new active glazing that does not have the aforementioned disadvantages.

For this purpose, the invention proposes an active glazing system comprising:

a double glazing, itself comprising two transparent plates that together delimit therebetween an intermediate volume filled with gas; and

a control device that is capable of reversibly producing a transition in a volatile compound between a dry vapour state and a supersaturated vapour state.

A quantity of the volatile compound is present in the intermediate volume of the double glazing. When the dry vapour state is produced in this intermediate volume by the control device, the volatile compound is entirely in vapour form and the double glazing is transparent. Therefore, an instruction to change from the dry vapour state to the supersaturated vapour state results in a condensation of the volatile compound into droplets that are distributed over at least one portion of a surface of at least one of the two plates, facing the intermediate volume. These droplets therefore cause light diffusion, which reduces the transparency of the double glazing. In other words, the droplets of the saturated vapour state generate an increase in the translucency of the double glazing.

The dry vapour state thus corresponds to the state of maximum transparency. The condensation of the volatile compound into droplets reduces this transparency. According to an additional characteristic of the invention, the surface portion of the plates on which the volatile compound condenses is such that an angle of contact of the droplets of the volatile compound with the surface is greater than 70° . The state of the glazing that is produced by the condensation of the volatile compound is thus sufficiently optically diffusing to obstruct the view through the double glazing. The transition that is thus made for the active glazing system, between the transparent state and a diffusing state, is reversible.

Such a system therefore does not require any PDLC film or electrodes, thus resulting in the possibility of reducing its manufacturing cost. Moreover, the volatile compound implemented in an active glazing system according to the invention, can be inexpensive, such as water or ethylene glycol.

Finally, a system according to the invention has a double-glazing structure with an intermediate volume that is filled with gas. It therefore has acoustic insulation and thermal insulation efficiencies.

In preferred embodiments of the invention, one or more of the following improvements may be used:

the control device may be adapted to vary a pressure of the volatile compound inside the intermediate volume;

the gas contained inside the intermediate volume may be a mixture of the volatile compound and an inactive gas component;

the surface portion of the plates on which the volatile compound condenses may be such that the angle of contact of the droplets of the volatile compound with the surface is greater than 80°, preferably greater than 90°;

the system may be adapted such that the condensation of the volatile compound on the surface portion of the plates produces the droplets, the diameters of which are between 20 μm and 60 μm (micrometre), and with a surface coverage yield of the plate's surface portion that is between 40% to 60%;

the surface portion of the plates on which the volatile compound condenses may comprise a coating or a texturing designed to modify the angle of contact of the droplets of the volatile compound with the surface, with respect to a base material of this plate. In such a case, the coating or texturing can have patterns that are designed to control a distribution of the droplets on the surface of the plate;

the control device may comprise two flow regulators arranged to control a first flow of a gaseous component devoid of any droplet-forming volatile compound, and a second flow of another gaseous component containing the droplet-forming volatile compound under supersaturation conditions. The two flow regulators are thus connected in order to jointly inject the first and second flows into the intermediate volume; and

the active glazing system may further comprise a volatile compound collector, connected to a discharge outlet of the intermediate volume of the double glazing. Such a collector may include a condenser designed to liquefy a vapour of the volatile compound that is extracted from the intermediate volume by the discharge outlet. Advantageously, the control device may thus comprise a generator for generating the vapour of the volatile compound, in particular a generator for generating a pressurised vapour of the volatile compound, which is connected to inject the vapour of the volatile compound into the intermediate volume. In such a case, the condenser outlet may be connected to a supply inlet of the vapour generator for the supply of the volatile compound in liquid form.

In a general manner, an active glazing system according to the invention may form a building or vehicle glazing, an interior partition wall, a projection screen, a solar diffuser, a light source diffuser, or a vision blurring device.

Other specific features and advantages of this invention will become apparent from the description below of non-limiting example embodiments, provided with reference to the appended figures, wherein:

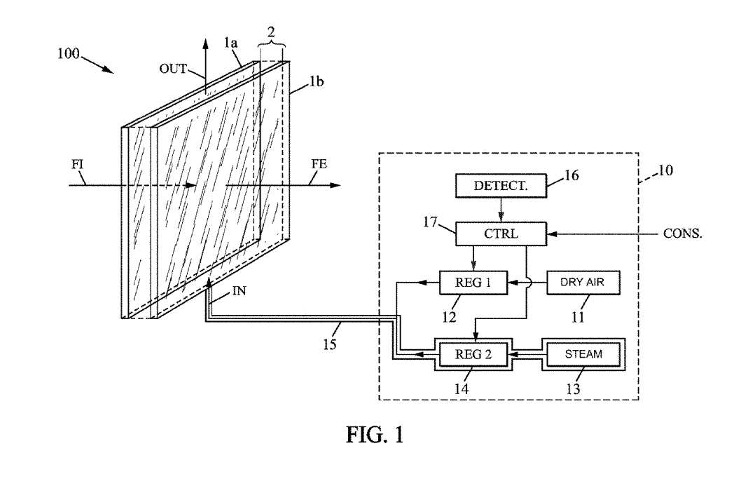

FIG. 1 shows an active glazing system according to the invention;

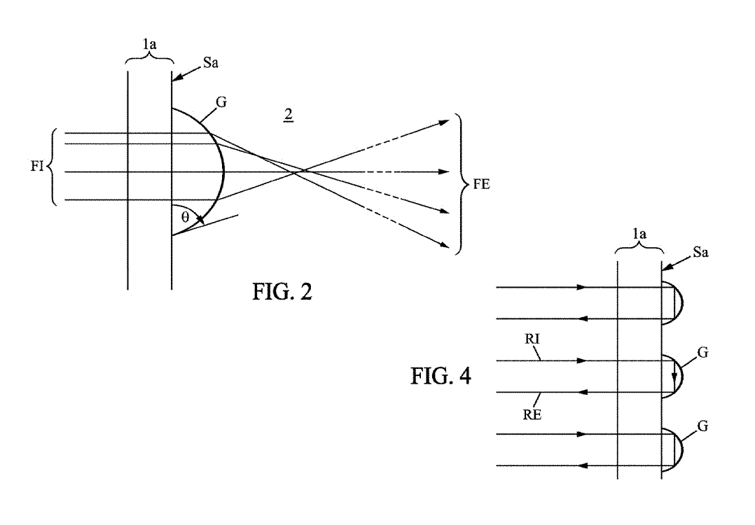

FIG. 2 is a block diagram illustrating the diffusing state of an active glazing system according to the invention;

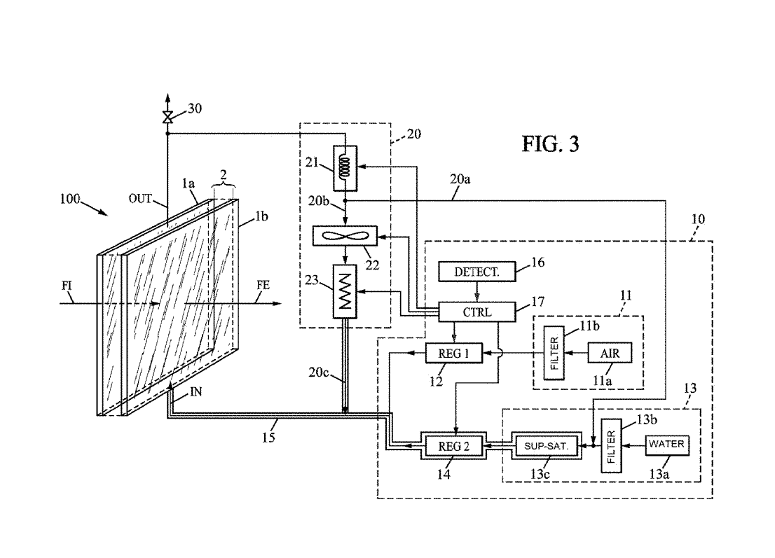

FIG. 3 corresponds to FIG. 1 with one improvement of the invention; and

FIG. 4 is another block diagram illustrating a specific application of an active glazing system according to the invention.

For clarity purposes, the dimensions of the elements shown in these figures do not correspond to actual dimensions nor to actual dimension ratios. Moreover, identical references provided in different figures refer to identical elements or elements with identical functions.

A system according to the invention, that is referred to in a general manner by the reference number 100, comprises the two transparent plates 1a and 1b, which form a double glazing, and the control device 10. The two plates 1a and 1b can be made from any material that is transparent for the incident light beam FI. They can, for example, be made from glass or PMMA. They delimit an intermediate volume 2, with additional peripheral junction elements that are not illustrated. In preferred embodiments of the double glazing, the plates 1a and 1b are parallel, and the additional elements comprise a peripheral spacer that is rigidly connected to each plate. The intermediate volume 2 can have a thickness that is intermediate between 0.5 mm and 30 cm, preferably less than 5 cm.

Optionally, the plates 1a and 1b, in addition to the intermediate volume 2, can form part of a triple glazing, which thus further comprises a third transparent plate, a second inter-plate intermediate volume, and additional peripheral junction elements adapted to suit such a triple glazing structure. In other words and in a general manner with regard to the invention, the double glazing concerned by the invention can be a part of a triple glazing.

The double glazing is arranged so as to be able to vary the composition of the gas that is contained within the intermediate volume 2. For example, the peripheral spacer is connected in an airtight manner to each plate 1a and 1b, and comprises a gaseous inlet referenced IN as well as a gaseous outlet referenced OUT. The tangible materialisations of the inlet IN and the outlet OUT can be ordinary. However, they are advantageously provided to allow for a fast renewal of the entire quantity of gas contained in the volume 2. For this purpose, the inlet IN and the outlet OUT can be located at opposite points on the periphery of the double glazing.

The control device 10 is designed to inject a gas of variable composition into the intermediate volume 2. FIG. 1 illustrates one possible composition of the device 10, in which two gas supply lines are connected in parallel to the inlet IN.

The first gas supply line comprises, for example, a dry air source 11 and a first flow regulator 12, referenced REG1. The second gas supply line can be designed to supply steam. For this purpose, it comprises the steam source 13 and a second flow regulator 14, referenced REG2.

The second gas supply line is designed to convey the steam into the intermediate volume 2, in a supersaturated vapour state when the dry air flow that is controlled by the regulator 12 is zero. For this purpose, the second gas supply line can be equipped with a heat trace cable 15, in order to maintain the water in gaseous state throughout the length of the second supply line, as far as the inlet IN in the intermediate volume 2.

A supersaturated vapour state is understood as referring to conditions such that the pressure of the steam at the level of the inlet IN is greater than the saturation vapour pressure value of the water for the temperature present in the intermediate volume 2. In a known manner, the saturation vapour pressure value of the water for a determined temperature is the pressure value for which the gaseous phase of the water and the liquid phase of the water coexist in a stable manner. Optionally, the steam pressure to be considered is the partial pressure, when the steam is mixed with an inactive gas, such as dry air.

For a given temperature of the intermediate volume, when the water pressure is less than the saturation vapour pressure value, the water is only present in gaseous form, i.e. in the form of a vapour, without the presence of liquid, in the intermediate volume 2. Such a water state, exclusively in vapour form, is often referred to as dry vapour. The water no longer has any effect on the beam FI that passes through the double glazing. The beam FI therefore exits the other side, in the form of an emerging beam referenced FE, and which has a propagation direction identical to that of the beam FI before passing through the double glazing. In other words, the double glazing allows for a distinct view of an observer located on one side of the double glazing, and who is looking at objects located on the other side of the double glazing. This is the transparent state of the system. This state is in particular obtained when the gas that is present in the intermediate volume 2 has been supplied by the first gas supply line.

When the second gas supply line is actuated to inject a sufficient quantity of supersaturated steam into the intermediate volume 2, the water condenses into droplets on at least one of the surfaces of the plates 1a and 1b facing towards the volume 2. Condensation firstly occurs on the coldest of the two plates 1a and 1b, when the two plates 1a and 1b have different respective temperatures. FIG. 2 illustrates the optical effect of a droplet. In this figure, the reference Sa refers to the surface of the plate 1a that is facing the intermediate volume 2, and G refers to a droplet. The droplet G deflects the light rays of the incident beam FI, thus resulting in a light diffusion which blurs the view of an observer through the double glazing. The optical state of the system is diffusing, or translucent. The water condensation that can occur simultaneously on the plate 1b results in an additional diffusion, and the emerging light beam FE is thus a result of these two successive diffusions. Preferably, the quantity of water that is condensed in the droplets can be adjusted so that the light diffusion obtained corresponds to the Mie light scattering conditions, resulting in a potentially very effective blurring of the view. The system remains in the diffusing or translucent optical state as long as the water pressure in the intermediate volume 2 stays constant. In a general manner, the individual size of each droplet can vary between several tens of nanometres and several tens of micrometres.

The system can be instructed to return to the transparent state by stopping the flow of supersaturated steam and by injecting a sufficient flow of dry air via the first gas supply line. The water pressure in the intermediate volume 2 therefore falls below the saturation vapour pressure value, such that the droplets are evaporated. The water in vapour form is evacuated via the outlet OUT. Gradual transitions between the diffusing state and the transparent state of the system can be obtained by simultaneously activating the first and second gas supply lines, so as to inject into the intermediate volume 2 a mixture of air and steam, with variable air and water proportions. In such a mixture, the air is a gaseous component that is inactive with regard to the optical operation of the system.

The switching processes of such an active glazing system according to the invention, between the transparent state and a diffusing state, can be controlled using a feedback. For example, a detector 16 measures a characteristic of the state of the double glazing in real time, and transmits a measurement signal to a controller 17, referenced CTRL. Independently, the controller 17 receives an instruction CONS that identifies a state of the double glazing to be produced, for example the transparent state, or a diffusing state. The controller 17 thus actuates the flow regulators 12 and 14 according to the instruction and the detection signal.

The detector 16 can be a sensor for detecting the water pressure in the intermediate volume 2. Such sensors are known by one of ordinary skill in the art and are easy to implement in the volume 2. Preferably, the detector 16 can be designed to measure the level of diffuse light transmission produced by the double glazing. Such a control mode is more direct and more accurate compared to the optical function of the active glazing system.

Among the possible improvements to the systems according to the invention, the surfaces of the plates 1a and 1b oriented inwards towards the intermediate volume 2 can undergo treatment to adapt or increase the angle of contact of the water with said plates. The angle of contact of the droplet G with the surface Sa bears the reference 0 in FIG. 2. It can be measured using the known sessile drop method, for example using a goniometer. According to this method, a drop of liquid of the volatile compound, for example ultra-pure water, is deposited using a syringe onto the surface of the plate. The method then consists of measuring the angle between the tangent to the profile of the droplet and the surface of the plate, at the level of the triple plate/liquid/gas contact line, possibly using a camera. On this subject, one can refer to chapter 1 of the works entitled “Surface Science techniques”, G. Bracco, B. Holst (eds.), Springer Series in Surface Sciences 51, Springer-Verlag Berlin Heidelberg 2013, or to the article entitled “Wetting of Heterogeneous Nanopatterned Inorganic Surfaces”, by M. Jam et al., Chem. Mater. 2008, 20, pp. 1476-1483.

In a known manner, hydrophobic treatments of the surface Sa allow for an increase in the angle of contact θ, in particular up to values exceeding 80°, or even in excess of 90°. Such a treatment can consist of depositing silicon-based molecules and/or molecules containing fluorine atoms or hydrocarbon groups onto the surface Sa. Numerous deposition methods can be used to form a hydrophobic coating, in particular vacuum deposition methods, deposition by dipping into then removing from a bath, vapour phase functionalisation methods, or deposition by ink jet or spraying through masks, which allow for the selective deposition of hydrophobic compounds in determined areas of the surfaces of the plates 1a and 1b.

The inventors have observed that droplets with a diameter of about 40 μm (micrometre) and that are substantially uniformly distributed on the surface of the plate 1a or 1b with a surface coverage yield of about 50%, in combination with the angle of contact value greater than 70°, produce a particularly effective light diffusion. In particular, such conditions ensure the effective blurring of human vision at a distance of 10 cm (centimetre) without the droplets being individually visible.

Moreover, the creation of limited areas of hydrophilic or hydrophobic behaviour on the plates 1a and 1b, with submillimetric patterns, can be used to control the uniformity of the nucleation of the droplets during a transition from the transparent state of the system to a diffusing state. For example, a distribution of such areas according to a regular network, for example a hexagonal-type network, allows for a high and uniform droplet density to be obtained. Such patterns can also limit the spread of the droplets on the plates 1a and 1b, so much so that for an identical quantity of condensed water, the droplets are thicker from a perpendicular perspective to the plates 1a and 1b, and produce a more significant light diffusion. The translucency of the double glazing in the diffusing state can therefore be adjusted.

Finally, the hydrophobic treatment of the plates 1a and 1b can take place in accordance with macroscopic patterns, for example using masks during treatment, such that the droplets only appear in predetermined portions of the double glazing. Such macroscopic patterns can have an aesthetic function for example.

It is understood that numerous variants and alternatives can be introduced with regard to the embodiments described hereinabove. In particular, the water used to form the droplets by condensation can be replaced by another volatile compound, such as ethylene glycol for example. In a general manner, the volatile compound can be selected according to its condensation temperature, its evaporation speed, its angle of contact on the surface of the plates 1a and 1b, or the nucleation density of the droplets during a transition to a diffusing state, etc.

Numerous alternative embodiments can also concern the control device 10. In particular, the second gas supply line of the device described hereinabove with reference to FIG. 1, can be replaced by a steam generator such as a pressurised steam generator, or such as a generator producing steam by scrubbing an inactive gas in a liquid water reservoir. In a general manner, the operating parameters of such supersaturated steam supply devices can be easily adjusted by one of ordinary skill in the art.

The embodiment of the invention illustrated in FIG. 3 uses a pressurised steam generator in the second gas supply line. The steam source 13 can thus comprise, arranged in series, listed in the order corresponding to the direction of flow, a liquid water source 13a, a filter 13b and the pressurised steam generator 13c. In parallel, the dry air source 11 can comprise an air source 11a that is followed by a filter 11b, that can be a drier filter.

With reference to FIG. 1, the system in FIG. 3 is complemented by a volatile compound collector 20. This collector 20 includes a condenser 21, in order to re-liquefy the volatile compound extracted from the outlet OUT. Therefore, for the example using air with steam, the air and the liquid water can be separated at the outlet of the condenser 21. The liquid water thus separated can be recycled by a dedicated line 20a, which connects the liquid outlet of the condenser 21 to the source 13, upstream of the pressurised steam generator 13c. The gas outlet of the condenser 21 can be connected via a separate line 20b to a fan 22 and a heating unit 23 arranged in series, and connected to the inlet IN via the line 20c. The operation of the condenser 21, fan 22 and heating unit 23 can be controlled by the controller 17. Optionally, the outlet OUT can be equipped with a valve 30, to prevent the generation of an overpressure at the inlet of the collector 20, in particular when a fast transition of the optical state of the double glazing is actuated by the controller 17. Optionally, the collector 20 can be shared by multiple active glazing systems, each of which comply with this invention.

Finally, the invention is compatible with the use of numerous additional coatings, applied on the plates 1a and 1b to provide additional functions thereto, such as an anti-reflection function or a low-emitting function for example.

An active glazing system according to the invention can be intended for numerous uses, in particular in the field of external glazing, for buildings or motor vehicles, interior design or furnishing.

One specific application of a system according to the invention can be the production of a retroreflective screen, as illustrated in FIG. 4. For this application, the volatile compound will preferably be chosen to have a high light refractive index value. FIG. 4 shows incident light rays RI that are retroreflected by the droplets G. RE refers to such a retroreflected ray. More specifically, each droplet G constitutes a concave micro-mirror, capable of transforming an incident light beam that is substantially parallel, into a divergent retro-reflected beam. The viewing angle of the screen by users can thus be wide. For this purpose, the volatile compound will preferably be chosen to have an angle of contact on the plates 1a and 1b that is close to 90°. For this application in the manufacture of screens, the use of a regular network of areas, the hydrophobicity of which is variable between adjacent areas, is advantageous for improving the quality and uniformity of the brightness of the image.

Finally, when the droplets are formed with an interval between neighbouring droplets of less than 45 micrometres, such a screen has a resolution that is at least three times higher than that of a high-definition (HD) screen.

1. Active glazing system (100) comprising:
a double glazing, itself comprising two transparent plates (1a, 1b) that together delimit therebetween an intermediate volume (2) filled with gas; and
a control device (10), capable of reversibly producing a transition in a volatile compound between a dry vapor state and a supersaturated vapor state,
so that when the dry vapor state is produced in the intermediate volume (2), the volatile compound present in said intermediate volume is entirely in vapor form and the double glazing is transparent,
and so that an instruction to change from the dry vapor state to the supersaturated vapor state results in a condensation of said volatile compound into droplets distributed over at least one portion of a surface (Sa) of at least one of the two plates (1a, 1b), facing the intermediate volume (2), the droplets producing a light diffusion that reduces the transparency of the double glazing,
wherein the surface portion of the plates on which the volatile compound condenses is such that an angle of contact (0) of the droplets of the volatile compound with the surface is greater than 70°.

2. Active glazing system according to claim 1, wherein the control device (10) is adapted to vary a pressure of the volatile compound inside the intermediate volume.

3. Active glazing system according to claim 1, wherein the volatile compound is water or ethylene glycol.

4. Active glazing system according to claim 1, whreein the gas contained inside the intermediate volume (2) is a mixture of the volatile compound and an inactive gas component.

5. Active glazing system according to claim 1, whrein the surface portion (Sa) of the plates (1a, 1b) on which the volatile compound condenses is such that the angle of contact (θ) of the droplets of the volatile compound with the surface is greater than 80°, prcfcrably grcatcr than 90°.

6. Active glazing system according to claim 1, adapted so that the condensation of the volatile compound on the surface portion (Sa) of the plates (1a, 1b) produces the droplets with droplet diameters between 20 μm and 60 μm, and with a surface coverage yield of said plate's surface portion of between 40% and 60%.

7. Active glazing system according to claim 1, wherein the surface portion (Sa) of the plates (1a, 1b) on which the volatile compound condenses comprises a coating or a texturing designed to modify the angle of contact (θ) of the droplets of the volatile compound with the surface, with respect to a base material of said plate.

8. Active glazing system according to claim 7, wherein the coating or texturing has patterns designed to control a distribution of the droplets on the surface (Sa) of the plate (1a, 1b).

9. Active glazing system according to claim 1, wherein the control device (10) comprises two flow regulators (11, 13), arranged to control a first flow of a gaseous component devoid of any volatile compound, and a second flow of another gaseous component containing the volatile compound under supersaturation conditions, and connected in order to jointly inject the first and second flows into the intermediate volume (2).

10. Active glazing system according to claim 1, wherein the control device (10) comprises a generator for generating a pressurized vapor of the volatile compound, connected to inject the pressurized vapor into the intermediate volume (2).

11. Active glazing system according to claim 1, forming a building or vehicle glazing, an interior partition wall, a projection screen, a solar diffuser, a light source diffuser, or a vision blurring device.

12. Active glazing system according to claim 2, wherein the volatile compound is water or ethylene glycol.

13. Active glazing system according to claim 2, wherein the gas contained inside the intermediate volume (2) is a mixture of the volatile compound and an inactive gas component.

14. Active glazing system according to claim 3, wherein the gas contained inside the intermediate volume (2) is a mixture of the volatile compound and an inactive gas component.

15. The active glazing system of claim 5, wherein the angle of contact (8) of the droplets of the volatile compound with the surface is greater than 90°.

16. Active glazing system according to claim 2, wherein the surface portion (Sa) of the plates (1a, 1b) on which the volatile compound condenses is such that the angle of contact (θ) of the droplets of the volatile compound with the surface is greater than 80°.

17. Active glazing system according to claim 3, wherein the surface portion (Sa) of the plates (1a, 1b) on which the volatile compound condenses is such that the angle of contact (θ) of the droplets of the volatile compound with the surface is greater than 80°.

18. Active glazing system according to claim 4, wherein the surface portion (Sa) of the plates (1a, 1b) on which the volatile compound condenses is such that the angle of contact (θ) of the droplets of the volatile compound with the surface is greater than 80°.

19. Active glazing system according to claim 2, adapted so that the condensation of the volatile compound on the surface portion (Sa) of the plates (1a, 1b) produces the droplets with droplet diameters between 20 μm and 60 μm, and with a surface coverage yield of said plate's surface portion of between 40% and 60%.

20. Active glazing system according to claim 3, adapted so that the condensation of the volatile compound on the surface portion (Sa) of the plates (1a, 1b) produces the droplets with droplet diameters between 20 μm and 60 μm, and with a surface coverage yield of said plate's surface portion of between 40% and 60%.
